(19) United States
(12) Patent Application Publication
(10) Pub. No.: US 2017/0094993 A1
(43) Pub. Date: Apr. 6, 2017

(54) PROCESS FOR MANUFACTURING A PRODUCT INCLUDING STARCH BALL

(71) Applicant: LIN-KUEI KUO, Taichung City (TW)

(72) Inventor: LIN-KUEI KUO, Taichung City (TW)

(21) Appl. No.: 14/875,154

(22) Filed: Oct. 5, 2015

(51) Int. Cl. A23L 1/28

(52) U.S. Cl. CPC A23L 1/2145; A23L 1/0522; A23L 1/0128; A23V 2002/00

(57) ABSTRACT

A process for manufacturing a product including starch ball is provided. The process includes following steps: water is stirred during heating water to average a temperature of water, and starch balls in water are stirred during heating process to uniform heat to the starch balls; a turbulent cleaning mechanism surroundingly washes the starch balls with a turbulent flow; the starch balls and a fluid-state sugar material which at least contains black sugar are mixed and heated, and an appropriate proportion of white gourd sugar ingredient is optionally added; and the starch balls are accomplished.

### BACKGROUND OF THE INVENTION

Field of the Invention

The present invention relates to a starch ball, and more particularly to a process for manufacturing a product including starch ball.

Description of the Prior Art

Conventionally, a product including starch ball is made from, for example, tapioca flour. The tapioca flour is first mixed with water to form ball-shaped products, the ball-shaped products are kneaded, extra flour is sieved out, and then the ball-shaped products are cut and kneaded to be granular products. The product including starch ball is added in various drinks and is popular among people because the product including starch ball is chewy and matches various drinks.

Usually, when cooking the product including starch ball, the product including starch ball is cooked and braised for decades of minutes, washed and drained, added with fructose and stirred. However, in this type of manufacturing method, the product including starch ball is mostly flushed with a stream of water and washed by hand, so viscous matter on a surface of each starch ball cannot be washed completely and the surface of each starch ball cannot contact the stream of water thoroughly. Therefore, the product including starch ball does not have preferable texture. In addition, the product including starch ball which is added with fructose has a monotonous flavor without fragrance. Such process for manufacturing the product including starch ball is disclosed in TW200836638.

The present invention has arisen to mitigate and/or obviate the afore-described disadvantages.

### SUMMARY OF THE INVENTION

The major object of the present invention is to provide a process for manufacturing a product including starch ball, which can manufacture the product including starch ball with chewy texture and fragrance of black sugar easily, quickly and in a large amount.

To achieve the above and other objects, a process for manufacturing the product including starch ball is provided, including following steps of: (a) putting starch balls into a container and heating the starch balls to form a first semi-finished product; (b) washing the first semi-finished product surroundingly with a turbulent flow in a turbulent cleaning machine to form a second semi-finished product; (c) processing the second semi-finished product with a low temperature; (d) preparing a fluid-state sugar material, the fluid-state sugar material at least including black sugar ingredient; and (e) mixing and heating the second semi-finished product and the fluid-state sugar material.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart showing a preferred embodiment of a process for manufacturing a product including starch ball of the present invention;

FIGS. 2 to 11 are drawings showing a preferred embodiment of a system for manufacturing the product including starch ball of the present invention; and

FIG. 12 is a drawing showing a preferred embodiment of the product including starch ball of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

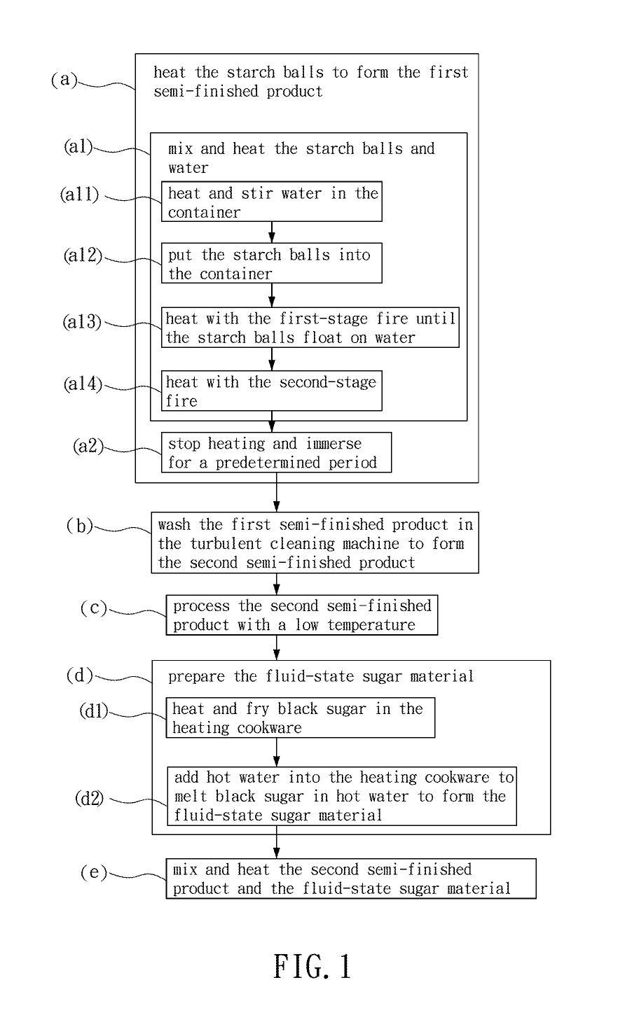

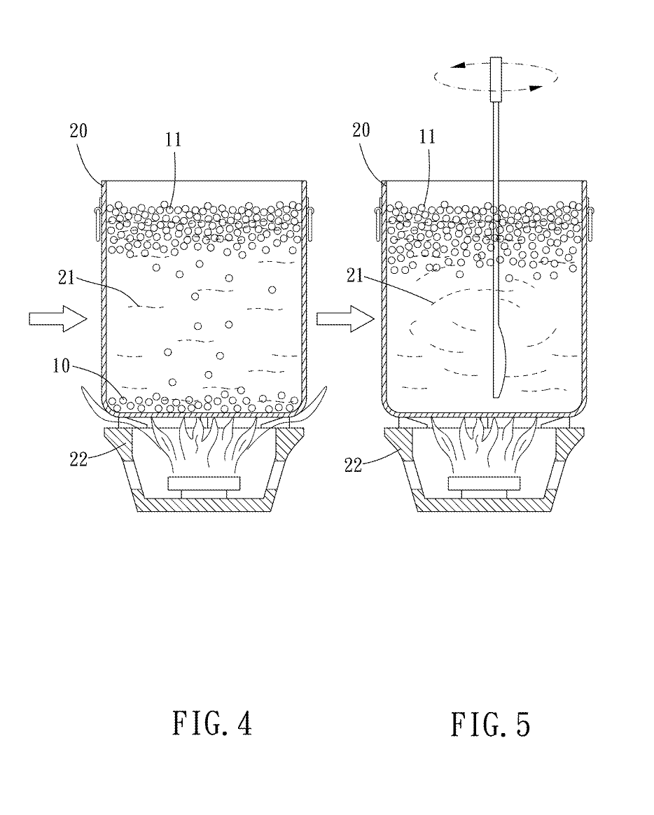

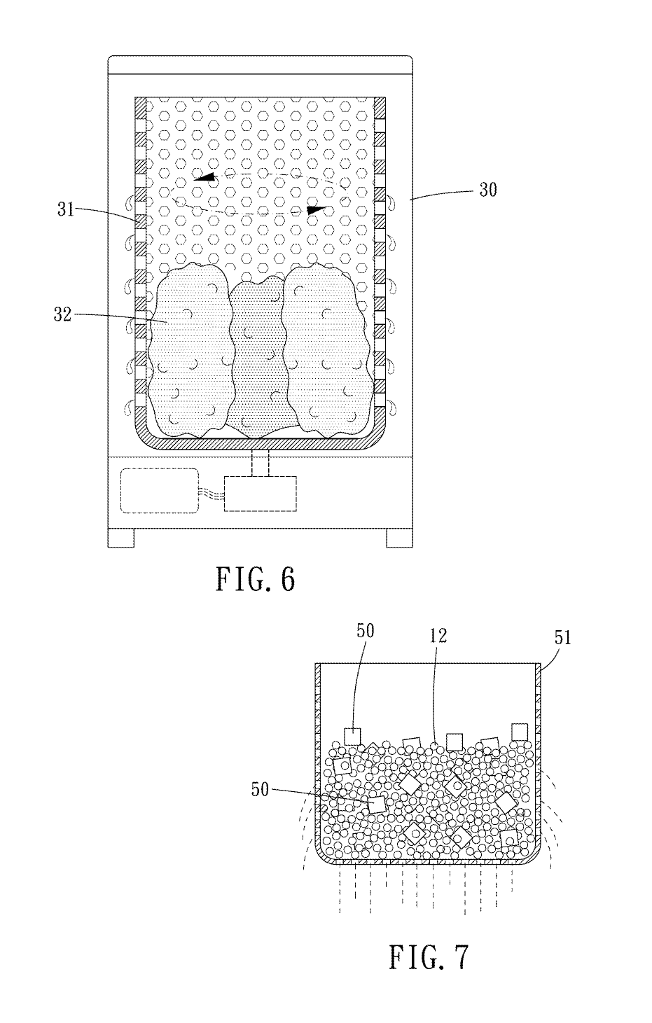

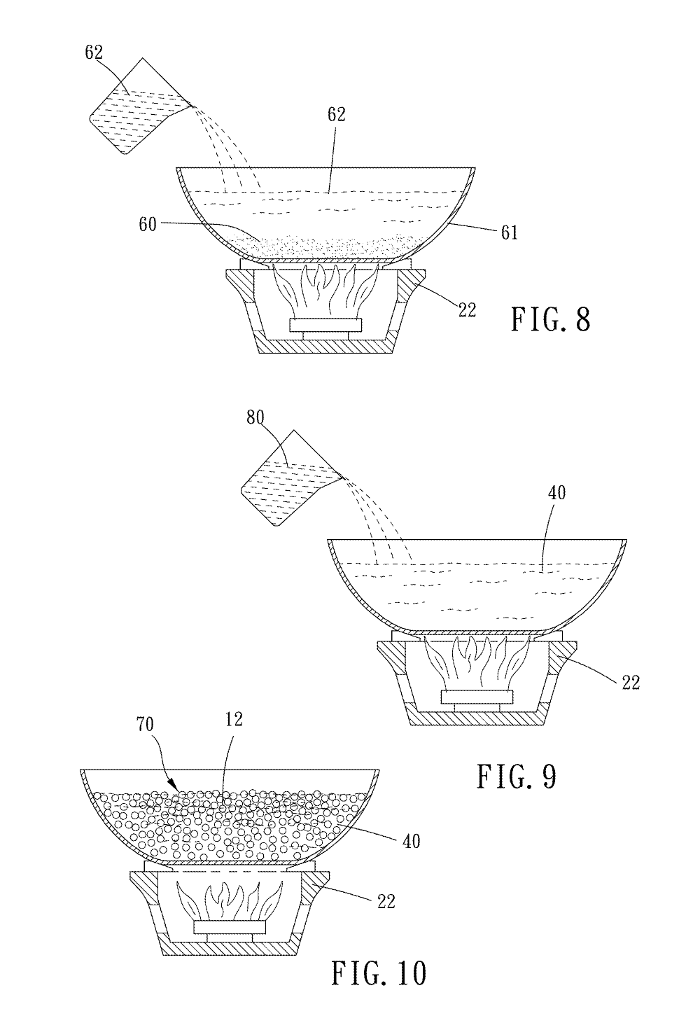

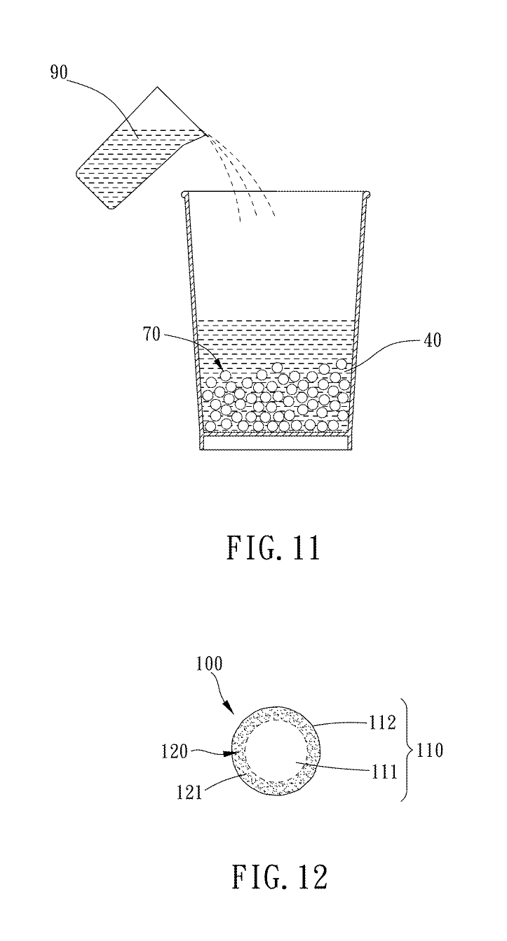

Please refer to FIGS. 1 to 11 for a preferred embodiment of the present invention. A process for manufacturing a product including starch ball includes following steps of: (a) putting starch balls 10 into a container 20 and heating the starch balls 10 to form a first semi-finished product 11; (b) washing the first semi-finished product 11 surroundingly with a turbulent flow in a turbulent cleaning machine 30 to form a second semi-finished product 12; (c) processing the second semi-finished product 12 with a low temperature; (d) preparing a fluid-state sugar material 40, the fluid-state sugar material 40 at least including black sugar ingredient; and (e) mixing and heating the second semi-finished product 12 and the fluid-state sugar material 40. Therefore, the product including starch ball with chewy texture and fragrance of black sugar can be easily and quickly manufactured in a large amount.

Wherein, the step (a) includes following steps of: (a1) putting the starch balls 10 and water 21 into the container 20 to heat the starch balls 10 and water 21 with a heating device 22, and a volume ratio of the starch balls 10 to water 21 is from 1:2 to 1:9; (a2) stopping heating the starch balls 10 and water 21 and immersing the starch balls 10 and water 21 for a predetermined period. Preferably, the volume ratio of the starch balls 10 to water 21 is 1:7 (for example, a bowl of the starch balls: 7 bowls of water), and the predetermined period is preferably substantially 2 hours (but not limited thereto) so as to ensure the starch balls 10 are cooked thoroughly. However, there may be 6 to 7 liters of water 21 and 2.5 to 3.5 kilograms (for example, 3.0 kilograms) of the starch balls 10; or a weight ratio of the starch balls 10 to water 21 may be substantially 1:7.

Specifically, the step (a1) includes following steps of: (a11) putting water 21 into the container 20 and heating water 21 until water 21 boils (normally, water boils at 100 degrees Celsius), and stirring water 21 during the heating process; (a12) putting the starch balls 10 into the container 20; (a13) heating water 21 and the starch balls 10 in the container 20 with a first-stage fire until the starch balls 10 float on water 21; and (a14) heating water 21 and the starch balls 10 in the container 20 with a second-stage fire, wherein the second-stage fire is of lower thermopower than the first-stage fire. Specifically, in the step (a13), water 21 and the starch balls 10 are heated with the first-stage fire (normally called full flame) for 1 to 3 minutes; in the step (a14), water 21 and the starch balls 10 are heated with the second-stage fire (normally called medium flame) for 8 to 12 minutes (for example, 10 minutes), and water 21 and the starch balls 10 in the container 20 are stirred every 2 to 3 minutes during the heating process. In the step (a11), water 21 in the container 20 is stirred to unify a temperature of water 21, and in the step (a13), the starch balls 10 in water 21 are stirred during heating process to uniform heat to the starch balls 10 so that the texture and quality of the product including starch ball may be identical.

In the step (b), the turbulent cleaning machine 30 is an automatic rotational turbulent machine. For example, the automatic rotational turbulent machine has a structure similar to a washing machine, an interior of the automatic rotational turbulent machine has a rotational perforated cleaning cylinder 31, and the automatic rotational turbulent machine has functions of adding water, cleaning, spinning and circulating. However, the automatic rotational turbulent machine may be any machine which can conduct a cleaning process with the turbulent flow surroundingly. In the step (b), preferably, the first semi-finished product 11 is contained in a perforated bag 32 and washed by the turbulent cleaning machine 30. Thereby, each said starch ball in the first semi-finished product 11 can be washed thoroughly in the turbulent flow, and the perforated bag 32 can ensure that the first semi-finished product 11 will not be damaged for contacting the automatic rotational turbulent machine directly. Therefore, the first semi-finished product 11 can be washed thoroughly without viscous matter on a surface of each said starch ball, and each starch ball of the second semi-finished product 12 is cooled thoroughly and uniformly and is more chewy.

In the step (c), preferably, the second semi-finished product 12 is cooled with ice 50 or/and ice water for 3 to 5 minutes. For example, the second semi-finished product 12 can be put into a perforated pot 51, and ice 50 or/and ice water is/are added into the perforated pot 51 to increase and maintain the chewy texture of the product including starch ball.

The step (d) includes following steps of: (d1) heating and frying black sugar 60 in a heating cookware 61 (for example, an iron wok); and (d2) adding hot water 62 (for example, water at 100 degrees Celsius) into the heating cookware 61 and heating and stirring to melt the black sugar 60 in the hot water 62 to form the fluid-state sugar material 40. In the step (d1), the black sugar 60 is heated sequentially with a third-stage fire for 1 to 2 minutes (for example, 1 minute) and with a fourth-stage fire for 8 to 12 minutes (for example, 10 minutes), wherein the fourth-stage fire (normally called medium-low flame) is of lower thermopower than the third-stage fire (normally called full flame), and in the step (d2), a heating period is 15 to 25 minutes (for example, 20 minutes).

In the step (e), the second semi-finished product 12 and the fluid-state sugar material 40 are mixed and heated to form a starch ball product 70. Wherein, in the step (e), a user only needs to mix the second semi-finished product 12 and the fluid-state sugar material 40 and cook the second semi-finished product 12 and the fluid-state sugar material 40 until they are boiled; however, the user may adjust according various requirements.

In this embodiment, before the step (e), white guard sugar ingredient 80 is further added into the fluid-state sugar material 40 in an appropriate proportion, and the white guard sugar ingredient 80 may be, for example, white guard tea in any concentration. In addition, after the step (e), milk 90 (for example, cow milk) may be further mixed with the starch ball product 70 in an appropriate proportion to manufacture bubble tea, peal milk tea or other similar products.

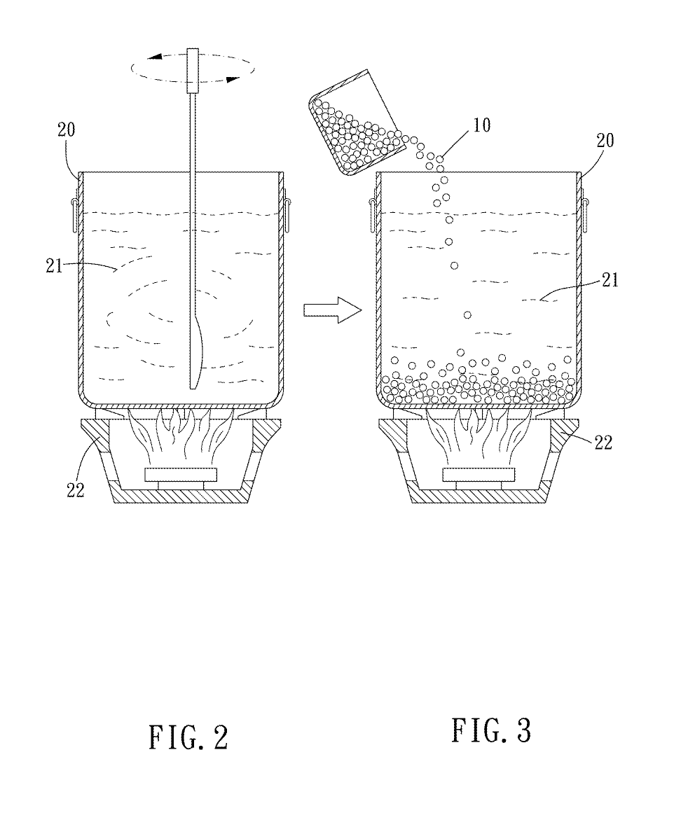

Please refer to FIGS. 2 to 9 for a system for manufacturing the product including the starch ball, including a heating device 22, a container 20, a turbulent cleaning machine 30, a low-temperature processing device and a heating cookware 61. The heating device 22 controllably adjusts a heating power, the heating device 22 may be a gas stove or an induction cooker, and the heating device 22 may include one or more heating units. The container 20 is optionally placed on the heating device 22 to be heated by the heating device 22, and the container 20 is for receiving the starch balls 10 and water 21 and for heating the starch balls 10 to form a first semi-finished product 11. The turbulent cleaning machine 30 receives the first semi-finished product 11 and surroundingly washes the first semi-finished product 11 with a turbulent flow to form a second semi-finished product 12. The low-temperature processing device receives the second semi-finished product 12 and processes the second semi-finished product 12 with ice 50 or/and ice water. The low-temperature processing device, for example, includes a perforated pot 51 and ice 50 or/and ice water contained in the perforated pot 51; and the low-temperature processing device may further include an ice maker or/and an ice water dispenser which can provide ice 50 or/and ice water directly. The heating cookware 61 receives a sugar material, for example, black sugar 60, and the sugar material in the heating cookware 61 is heated by the heating device 22 to form a fluid-state sugar material 40; therefore, the fluid-state sugar material 40 at least includes black sugar ingredient. The steps included in the process for manufacturing the product including starch ball can be realized through the system for manufacturing the product including starch ball; wherein each heating process in the process for manufacturing the product including starch ball can be accomplished by a same or different heating units of the heating device 22.

Please refer to FIG. 12, a product including the starch ball 100 is further provided, including a main body 110 and a sugar-soaked portion 120. The main body 110 includes a core 111 and an outer layer 112 wrapped outside the core 111. The sugar-soaked portion 120 is at least connected with the outer layer 112 directly or melted into the core 111, and the sugar-soaked portion 120 includes black sugar ingredient 121 and white guard sugar ingredient. Wherein, the main body 110 may be made from tapioca flour, flour or similar starches, and the product including starch ball 100 can be manufactured through the process and system for manufacturing the product including starch ball.

Given the above, water is stirred during the heating process to unify the temperature of water, the starch balls in water are stirred during heating process to uniform heat to the starch balls, the starch balls are surroundingly washed in the turbulent cleaning machine, and white guard sugar ingredient is further optionally added in an appropriate proportion; therefore, the product including starch ball which has chewy texture and fragrance of black sugar can be easily and quickly manufactured in a large amount.

While we have shown and described various embodiments in accordance with the present invention, it should be clear to those skilled in the art that further embodiments may be made without departing from the scope of the present invention.

What is claimed is:

1. A process for manufacturing a product including starch ball, including following steps of:
(a) putting starch balls into a container and heating the starch balls to form a first semi-finished product;
(b) washing the first semi-finished product surroundingly with a turbulent flow in a turbulent cleaning machine to form a second semi-finished product;
(c) processing the second semi-finished product with a low temperature;
(d) preparing a fluid-state sugar material, the fluid-state sugar material at least including black sugar ingredient; and
(e) mixing and heating the second semi-finished product and the fluid-state sugar material.

2. The process for manufacturing a product including starch ball of claim 1, wherein the step (a) includes following steps of:
(a1) putting the starch balls and water into the container and heating the starch balls and water, and a volume ratio of the starch balls to water is from 1:2 to 1:9;
(a2) stopping heating the starch balls and water and immersing the starch balls and water for a predetermined period.

3. The process for manufacturing a product including starch ball of claim 2, wherein in the step (a1), the volume ratio of the starch balls to water is 1:7; and in the step (a2), the predetermined period is 2 hours.

4. The process for manufacturing a product including starch ball of claim 3, wherein the step (a1) includes following steps of:
(a11) putting water into the container and heating water until water boils, and stirring water during the heating process;
(a12) putting the starch balls into the container;
(a13) heating water and the starch balls in the container with a first-stage fire until the starch balls float on water; and
(a14) heating water and the starch balls in the container with a second-stage fire, wherein the second-stage fire is of lower thermopower than the first-stage fire.

5. The process for manufacturing a product including starch ball of claim 4, wherein in the step (a13), water and the starch balls are heated with the first-stage fire for 1 to 3 minutes; in the step (a14), water and the starch balls are heated with the second-stage fire for 8 to 12 minutes, and water and the starch balls in the container are stirred every 2 to 3 minutes during the heating process.

6. The process for manufacturing a product including starch ball of claim 1, wherein in the step (b), the turbulent cleaning machine is an automatic rotational turbulent machine.

7. The process for manufacturing a product including starch ball of claim 1, wherein in the step (b), the first semi-finished product is contained in a perforated bag and washed by the turbulent cleaning machine.

8. The process for manufacturing a product including starch ball of claim 1, wherein in the step (c), the second semi-finished product is cooled with ice or/and ice water for 3 to 5 minutes.

9. The process for manufacturing a product including starch ball of claim 1, wherein the step (d) includes following steps of:
(d1) heating and frying black sugar in a heating cookware; and
(d2) adding hot water into the heating cookware, heating and stirring to melt the black sugar in the hot water to form the fluid-state sugar material.

10. The process for manufacturing a product including starch ball of claim 9, wherein in the step (d1), the black sugar is sequentially heated with a third-stage fire for 1 to 2 minutes and a fourth-stage fire for 8 to 12 minutes, wherein the fourth-stage fire is of lower thermopower than the third-stage fire; and in the step (d2), the heating period is 15 to 25 minutes.

11. The process for manufacturing a product including starch ball of claim 1, wherein before the step (c), white guard sugar ingredient is added into the fluid-state sugar material in an appropriate proportion.

12. The process for manufacturing a product including starch ball of claim 11, wherein the second semi-finished product and fluid-state sugar material are mixed and heated to form a starch ball product, and after the step (e), the starch ball product is mixed with milk in an appropriate proportion.
